(19) United States
(12) Patent Application Publication
(10) Pub. No.: US 2002/0089817 A1
(43) Pub. Date: Jul. 11, 2002

(54) Keypad protector for portable electronic device

(76) Inventor: Kenneth D. Eisenbraun, Bloomfield Village, MI (US)

Correspondence Address: Gifford, Krass, Groh, Sprinkle,, Anderson & Citkowski, P.C., Suite 400, 280 N. Old Woodward Avenue, Birmingham, MI, 48009-5394, US

(21) Appl. No.: 10/040,649

(22) Filed: Jan. 7, 2002

Related U.S. Application Data
(60) Provisional application No. 60/260,045, filed on Jan. 5, 2001.

(51) Int. Cl. G06F 1/16

(52) U.S. Cl. 361/680; 361/683

(57) ABSTRACT

A keypad protector includes a battery compartment cover adapted to secure over the battery compartment of a portable electronic device having a keypad and a flap attached to the cover that pivots to protect the keypad. The keypad protector is readily replaced upon damage without resort to electronic device manufacturer service.

### RELATED APPLICATION

This application claims priority of U.S. Provisional Patent Application 60/260,045 filed Jan. 5, 2001, and is incorporated herein by reference.

### FIELD OF THE INVENTION

The present invention relates generally to a portable electronic device keyboard protector, and in particular to the keypad protector attached to a portable electronic device through a battery compartment cover component.

### BACKGROUND OF THE INVENTION

Portable electronic devices such as the cellular telephone and PDA have become popular personal accompaniments. Carrying such portable electronic devices invariably leads to unintended pressure on the keypad resulting in spurious data entry, accidental communication links occurring, or inappropriate deactivation of the device. An electronic solution to this problem lies in a keypad lock mode that disables the keypad until a specified sequence is keyed into the device. While a keypad lock mode is functional, this approach suffers from being an inconvenient additional step a user must perform prior to using the device. Alternatively, many portable electronic devices are provided with a mechanical keypad cover that is flipped open to provide access to the keypad and other device components. These flip covers are often pivotally attached to one end of the device case and are integral components of the device. It is further often the case that such flip covers pivotally open to a maximal angle of, for example, about 120° to 150° relative to the cover closed position in order to allow keypad access. The mechanical failure of conventional keypad cover pivots, and mechanical shock in general are significant causes of portable electronic device damage. Owing to the inevitability of mechanical keypad cover damage, there exists a need for a keypad protector that is easily replaced without resort to electronic device manufacturer service.

### SUMMARY OF THE INVENTION

A keypad protector includes a battery compartment cover adapted to secure over the battery compartment of an electronic device having a keypad, and a flap pivotally attached to the battery compartment cover, the flap adapted to overlay a portion of the keypad. The battery compartment cover component is configured to have tabs, torsion plates and other securing elements configured to engage complimentary elements of the electronic device case. A keypad protector for a cellular telephone includes a battery compartment cover adapted to secure over a battery compartment of a cellular telephone having a keypad and a flap pivotally attached to the battery compartment cover adapted to overlay a portion of the keypad. The keypad protector is designed to pivot about an end or side of the cellular telephone case so as to provide access to device power, or docking fittings.

### BRIEF DESCRIPTION OF THE DRAWINGS

FIG. 1 is a perspective rearward view of the present invention in a closed position where a portable electronic device is shown in ghost;

FIG. 2 is a perspective frontal view of the keypad protector of FIG. 1;

FIG. 3 is a bottom view of the keypad protector of FIG. 1;

FIG. 4 is an exploded perspective view of an alternative keypad protector embodiment where the portable electronic device is shown in ghost; and

FIG. 5 is a bottom view of the alternative embodiment of FIG. 4.

### DETAILED DESCRIPTION OF THE PREFERRED EMBODIMENTS

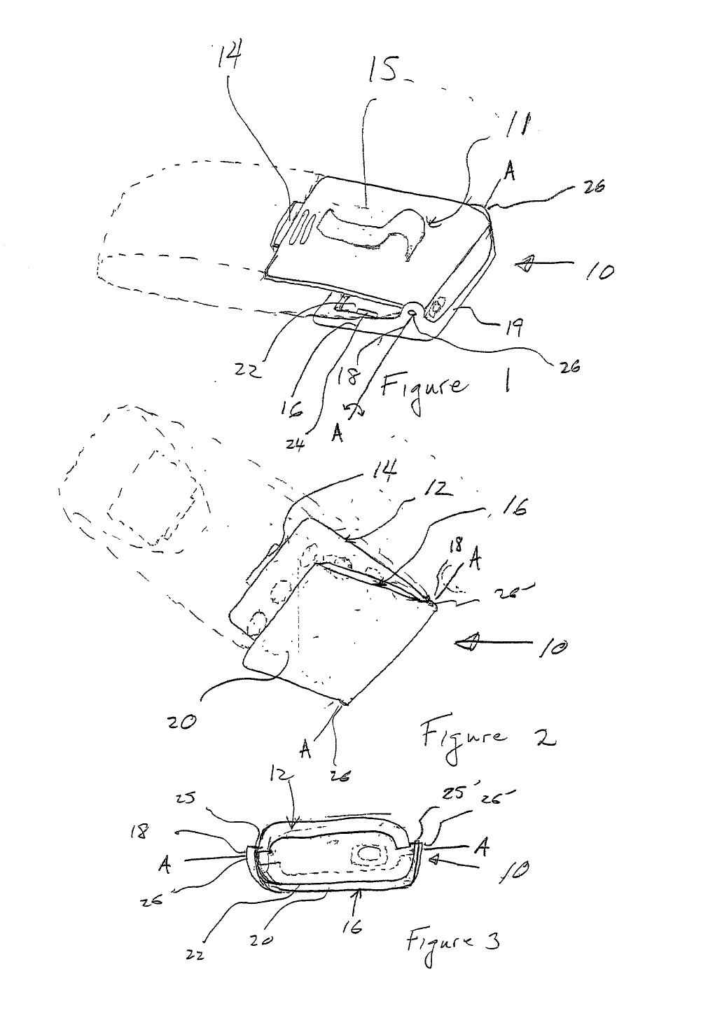

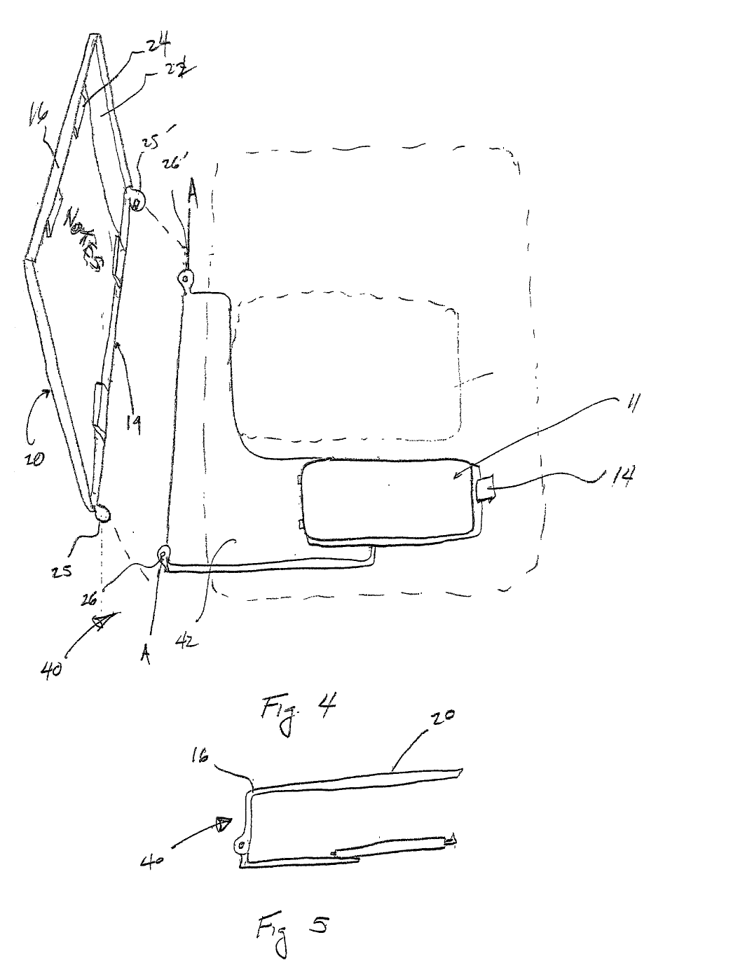

The present invention has utility as a keypad protector for a portable electronic device, specifically including a cellular telephone and a PDA, where a keypad as used herein is noted to also include a touch screen and a pressure sensor array. While the present invention is detailed with respect to the Nokia 8260 and 8290 series of cellular phones, it is appreciated that the present invention is readily adapted by one skilled in the art to afford similar keypad protection for a variety of cellular telephone makes and models. A keypad protector is shown generally at 10 in FIGS. 1-3. The keypad protector 10 has a battery compartment cover 11 adapted to engage complimentary coupling fittings integral to the portable electronic device case (shown in ghost form in FIGS. 1-3). The battery compartment cover 11 has a terminal locking tongue adapted to secure the keypad protector 10 to the cellular phone. Optionally, ridges 14 are provided on the external side 12 of the cover 11 to facilitate pressure release of the tongue 13. Optionally, a hook 15 or other conventional fixture is attached to the battery compartment cover 11 to facilitate securing of the cellular telephone to the apparel of a user. The battery compartment cover 11 engages a flap 16 adapted to overlay a portion of the keypad when the inventive protector 10 is in a closed position. It is appreciated that the protective nature of the invention extends beyond the actual dimension of the flap 16, and as such can be formed to a size less than the full keypad surface area. The cover 11 and flap 16 terminate in tabs 25 and 25′, each tab having an aperture therein 26 and 26′ respectively that upon alignment of the apertures 26 and 26′ a pivot axis A is defined. The battery compartment cover 11 and flap 16 are maintained in pivotal alignment with one another through a hinge pin 18. Alternatively, a conventional pivot pin-aperture pair of complimentary engaging dimensions are integrally formed into the cover and flap tabs thereby aligning the hinge pin 18. Preferably, the flap 16 of the invention has an end 19 spaced from the pivot axis A to allow access to power coupling, docking, or other fittings located in the base of a portable electronic device, as shown in U.S. Pat. No. 5,745,567, which is incorporated herein by reference. The flap and cover components of the invention are preferably constructed of impact resistant injection moldable plastic materials conventional to the art. Optionally the outer face 20 of the flap 16 is provided with indicia, embodiments or decorative ornamentation. Additionally, the inner face 22 of flap 16 provides a surface suitable for storage of alphanumeric data such as phone numbers, a photograph, a notepad or other thin sheet materials. Side grooves 24 are optionally provided to retain a thin sheet material in contact with the inner face 22.

Referring now to FIGS. 4 and 5, an alternative embodiment of an inventive keypad protector is shown generally at 40 with like numerals corresponding to those of FIGS. 1-3. The embodiment depicted in FIGS. 4 and 5 provides a flap opening along an axis parallel to a device side. The protector 40 has a battery compartment cover 11 integral or otherwise permanently fused to an extender portion 42. The extender portion 42 accommodates a displacement between a lateral device battery compartment and keypad. It is appreciated that the extender 42 can extend from the cover 11 in a variety of directions to provide for a flap pivot axis along either side, top, or bottom of a device.

The foregoing description is illustrative of particular embodiments of the invention, but is not meant to be a limitation upon the practice thereof. The following claims, including all equivalents thereof, are intended to define the scope of the invention.

I claim:

1. A cellular telephone keypad cover comprising:
a battery compartment cover adapted to secure over a cellular telephone battery compartment; and
a flap pivotally attached to said battery compartment cover and adapted to overlay a cellular telephone keypad.

2. The keypad cover of claim 1 further comprising an apparel attachment device attached to said battery cover.

3. The keypad cover of claim 1 further comprising said flap having an inner face adapted to store a thin sheet material.

4. The keypad protector of claim 1 wherein said flap is pivotally attached to said battery compartment cover with a hinge pin.

5. The keypad protector of claim 1 wherein said flap is pivotally attached to said battery compartment cover through a pivot pin in one component selected from a group of said flap and said cover and a complimentary aperture in the other of said flap or said cover.

6. The keypad protector of claim 1 wherein said flap has an end spaced from a pivot axis about which said flap is pivotally attached to said battery cover.

7. A keypad protector comprising:
a battery compartment cover adapted to secure over a battery compartment of a portable electronic device having a keypad, said battery compartment cover having an outward surface, the outward surface forming an extender having dimensions beyond that of the battery compartment; and
a flap pivotally attached to the extender and adapted to overlay a portion of the keyboard.

8. The keypad cover of claim 7 further comprising an apparel attachment device attached to said battery cover.

9. The keypad cover of claim 7 further comprising said flap having an inner face adapted to store a thin sheet material.

10. The keypad protector of claim 7 wherein said flap is pivotally attached to said battery compartment cover with a hinge pin.

11. The keypad protector of claim 7 wherein said flap is pivotally attached to said battery compartment cover through a pivot pin in one component selected from a group of said flap and said cover and a complimentary aperture in the other of said flap or said cover.

12. The keypad protector of claim 7 wherein said flap has an end spaced from a pivot axis about which said flap is pivotally attached to said battery cover.
